(19) United States
(12) Patent Application Publication
(10) Pub. No.: US 2021/0295132 A1
(43) Pub. Date: Sep. 23, 2021

(54) METHOD AND APPARATUS FOR GENERATING INTERACTIVE SCENARIO, AND ELECTRONIC DEVICE

(71) Applicant: BEIJING QINGZHOUZHIHANG INTELLIGENT TECHNOLOGY CO., LTD, Beijing (CN)

(72) Inventor: Xiaodong YANG, Beijing (CN)

(73) Assignee: BEIJING QINGZHOUZHIHANG INTELLIGENT TECHNOLOGY CO., LTD, Beijing (CN)

(21) Appl. No.: 17/032,726

(22) Filed: Sep. 25, 2020

(30) Foreign Application Priority Data
Mar. 20, 2020 (CN) 202010205356.4

(51) Int. Cl. G06N 3/04; G06N 3/08

(52) U.S. Cl. CPC G06N 3/0472; G06N 3/08; G06N 3/0445; G06N 3/0454

(57) ABSTRACT

A method and an apparatus for generating an interactive scenario, and an electronic device are provided. The method includes performing encoding processing on a first basic coordinate sequence of a target object and a second basic coordinate sequence of an interactive object to generate an encoded implicit state; determining an implicit state probability distribution corresponding to the encoded implicit state based on the encoded implicit state, and determining an initial implicit state by sampling; and performing decoding processing on the initial implicit state to determine a first coordinate sequence probability distribution of the target object and a second coordinate sequence probability distribution of the interactive object, determining a new coordinate sequence of the target object and a new coordinate sequence of the interactive object by sampling.

### FIELD

The present disclosure relates to the field of data generation technologies, and in particular to a method and an apparatus for generating an interactive scenario, an electronic device, and a computer readable storage medium.

### BACKGROUND

Autonomous driving, as a technology widely considered as being capable of significantly promoting progress in human society and economy, is advantageous for promoting the sharing economy and saving social resources due to significantly reduced traffic congestion, reduced traffic accidents, improved travel efficiency, released driving time, saved parking space, and increased vehicle utilization.

One of the most critical and challenging technologies for autonomous driving systems is how to effectively interact with surrounding vehicles in unfamiliar environments, considering the high diversity and complexity of interactive scenarios, and the inability to collect all possible interactive scenarios in experiments in practice. Simulation virtual tests are an important platform for simulating the interaction of autonomous vehicles with other vehicles. Simulation virtual tests allow an interactive scenario to be changed in a controlled environment, such that repeated tests can be performed to iteratively improve the autonomous driving system. However, in reality, it is impossible to perform thousands of actual drive test evaluations for each change in the system.

Therefore, how to generate a large amount of diverse vehicle interactive scenarios that effectively simulate real environments becomes one of the core technologies of simulation virtual tests. The current methods commonly adopted in the industry include: (1) manually creating an interactive scenario based on prior knowledge and experience, such as drawing way points of pedestrians and vehicles; and (2) manually selecting representative interactive scenarios from real log data, and editing the selected representative interactive scenarios, such as adding or removing related pedestrians or vehicles. (3) A large number of effective and diverse interactive scenarios are automatically generated, or vehicle driving trajectories are effectively predicted. For example, the moving trajectory of pedestrians or vehicles are generated or predicted by using convolutional social pooling, social long short-term memory, and social generative adversarial neural network. The shortcomings of the existing methods are that, the amount vehicle interactive scenarios that rely on manual drawing and filtering cannot be significantly increased, and existing automatic generation methods cannot generate diverse interactive scenarios that effectively simulate real environments and that are suitable for different traffic maps.

### SUMMARY

In order to solve the technical issue in the conventional technology, a method and an apparatus for generating an interactive scenario, an electronic device, and a computer readable storage medium are provided according to the embodiments of the present disclosure.

In first aspect, a method for generating an interactive scenario is provided according to an embodiment of the present disclosure. The method includes:

obtaining a first basic coordinate sequence of a target object and a second basic coordinate sequence of an interactive object, and performing encoding processing on the first basic coordinate sequence and the second basic coordinate sequence to generate an encoded implicit state;

determining an implicit state probability distribution corresponding to the encoded implicit state based on the encoded implicit state, and determining an initial implicit state by sampling based on the implicit state probability distribution;

performing decoding processing on the initial implicit state to determine a first coordinate sequence probability distribution of the target object and a second coordinate sequence probability distribution of the interactive object, determining a new coordinate sequence of the target object by sampling based on the first coordinate sequence probability distribution, and determining a new coordinate sequence of the interactive object by sampling based on the second coordinate sequence probability distribution.

In second aspect, an apparatus for generating an interactive scenario is provided according to an embodiment of the present disclosure. The apparatus includes an encoding module, a sampling state module, and a decoding sampling module.

The encoding module is configured to obtain a first basic coordinate sequence of a target object and a second basic coordinate sequence of an interactive object, and perform encoding processing on the first basic coordinate sequence and the second basic coordinate sequence to generate an encoded implicit state.

The sampling state module is configured to determine an implicit state probability distribution corresponding to the encoded implicit state based on the encoded implicit state, and determine an initial implicit state by sampling based on the implicit state probability distribution.

The decoding sampling module is configured to perform decoding processing on the initial implicit state to determine a first coordinate sequence probability distribution of the target object and a second coordinate sequence probability distribution of the interactive object, determine a new coordinate sequence of the target object by sampling based on the first coordinate sequence probability distribution, and determine a new coordinate sequence of the interactive object by sampling based on the second coordinate sequence probability distribution.

In a third aspect, an electronic device is provided according to an embodiment of the present disclosure. The electronic device includes a bus, a transceiver, a memory, a processor, and a computer program stored in the memory and executable by the processor. The transceiver, the memory, and the processor are connected with each other via the bus. The computer program, when executed by the processor, causes steps of the method for generating an interactive scenario according to any one of the above aspects to be performed.

In a fourth aspect, a computer-readable storage medium having stored thereon a computer program is provided according to an embodiment of the present disclosure. The computer program, when executed by a processor, causes steps of the method for generating an interactive scenario according to any one of the above aspects to be performed.

A method and an apparatus for generating an interactive scenario, an electronic device, and a computer readable storage medium are provided according to the embodiments of the present disclosure. Basic coordinate sequences extracted from a real interactive scenario are encoded and decoded, to generate new coordinate sequences that simulate real environments. The initial implicit state is determined by performing random sampling on the implicit state probability distribution, and the coordinates of the target object and the interactive object are obtained by performing random sampling on the coordinate sequence probability distribution during the decoding phase. Since random sampling is performed at two stages, generation of interactive scenarios has multiple modalities, and can be used for automatically generating multiple different interactive scenarios for a same map. In addition, during generation of an interactive scenario, the basic coordinate sequence of the object is extracted as input, and the parameters related to the map itself are weakened, such that the method is not limited to a specific map, that is, the method can also be applied to a variety of maps, to generate a variety of interactive scenarios in a variety of maps.

### BRIEF DESCRIPTION OF THE DRAWINGS

The drawings to be used in the description of the embodiments of the disclosure or the conventional technology will be described briefly as follows, so that the technical solutions according to the embodiments of the disclosure or according to the conventional technology will become clearer.

FIG. 1 shows a flow chart of a method for generating an interactive scenario according to an embodiment of the present disclosure;

FIG. 2 shows a schematic diagram of an overall structure of a model architecture applied in the method for generating an interactive scenario according to an embodiment of the present disclosure;

FIG. 3 shows a schematic diagram of the structure of the model architecture applied in the method for generating an interactive scenario that is developed in a chronological order according to an embodiment of the present disclosure;

FIG. 4 shows a first schematic structural diagram of an apparatus for generating an interactive scenario according to an embodiment of the present disclosure;

FIG. 5 shows a second schematic structural diagram of an apparatus for generating an interactive scenario according to an embodiment of the present disclosure; and

FIG. 6 shows a schematic structural diagram of an electronic device for executing a method for generating an interactive scenario according to an embodiment of the present disclosure.

### DETAILED DESCRIPTION OF EMBODIMENTS

In the description of the embodiments of the present disclosure, those skilled in the art should understand that the embodiments of the present disclosure may be implemented as a method, an apparatus, an electronic device, and a computer-readable storage medium. Therefore, the embodiments of the present disclosure may be embodied in the following forms: complete hardware, complete software (including firmware, resident software, microcode, etc.), a combination of hardware and software. In addition, in some embodiments, the embodiments of the present disclosure may also be implemented in the form of a computer program product in one or more computer-readable storage mediums, where the computer-readable storage mediums include computer program codes.

The computer-readable storage medium may be any combination of one or more computer-readable storage mediums. The computer-readable storage medium includes: an electronic, magnetic, optical, electromagnetic, infrared, or semiconductor system, apparatus, or device, or any combination thereof. More specific examples of computer-readable storage medium include: portable computer disk, hard disk, Random Access Memory (RAM), Read-Only Memory (ROM), Erasable Programmable Read-Only Memory (EPROM), flash memory, optical fiber, Compact Disc-Read Only Memory (CD-ROM), optical storage device, magnetic storage device or any combination of the above. In the embodiment of the present disclosure, the computer-readable storage medium may be any tangible medium containing or storing a program, and the program may be used by or in combination with an instruction execution system, apparatus, or device.

The computer program code contained in the computer-readable storage medium may be transmitted using any appropriate medium, including: wireless, wire, optical cable, Radio Frequency (RF) or any suitable combination thereof.

The computer program code for performing the operations of the embodiments of the present disclosure may be written in assembly instructions, Instruction Set Architecture (ISA) instructions, machine instructions, machine-related instructions, microcode, firmware instructions, state setting data, integrated circuit configuration data, or in one or more programming languages or combinations thereof. The programming languages includes an object-oriented programming language, such as Java, Smalltalk, C++, and a conventional procedural programming language, such as C language or similar programming language. The computer program code may be executed entirely on the user's computer, partly on the user's computer, as an independent software package, partly on the user's computer and partly on a remote computer, and entirely on the remote computer or server. In the case involving a remote computer, the remote computer may be connected to a user computer or an external computer through any kind of network, including a local area network (LAN) or a wide area network (WAN).

In the embodiments of the present disclosure, the provided method, apparatus, and electronic device are described by using flowcharts and/or block diagrams.

It should be understood that each block of the flowcharts and/or block diagrams, and combinations of blocks in the flowcharts and/or block diagrams, may be implemented by computer-readable program instructions. These computer-readable program instructions may be provided to a processor of a general-purpose computer, a special-purpose computer, or another programmable data processing device, thereby producing a machine. These computer-readable program instructions are executed by a computer or another programmable data processing device to produce an apparatus for implementing the functions/operations specified by the blocks in the flowcharts and/or block diagrams.

These computer-readable program instructions may also be stored in a computer-readable storage medium that enables a computer or another programmable data processing device to work in a specific manner. In this way, the instructions stored in the computer-readable storage medium produce an instruction device product that implements the functions/operations specified in the blocks of the flowcharts and/or block diagrams.

Computer-readable program instructions may also be loaded onto a computer, another programmable data processing device, or another device, such that a series of operating steps can be performed on a computer, another programmable data processing device, or another device to produce a computer-implemented process. Thus, the instructions executed on a computer or another programmable data processing device can provide a process for implementing the functions/operations specified by the blocks in the flowcharts and/or block diagrams.

In the following, the embodiments of the present disclosure are described with reference to the accompanying drawings.

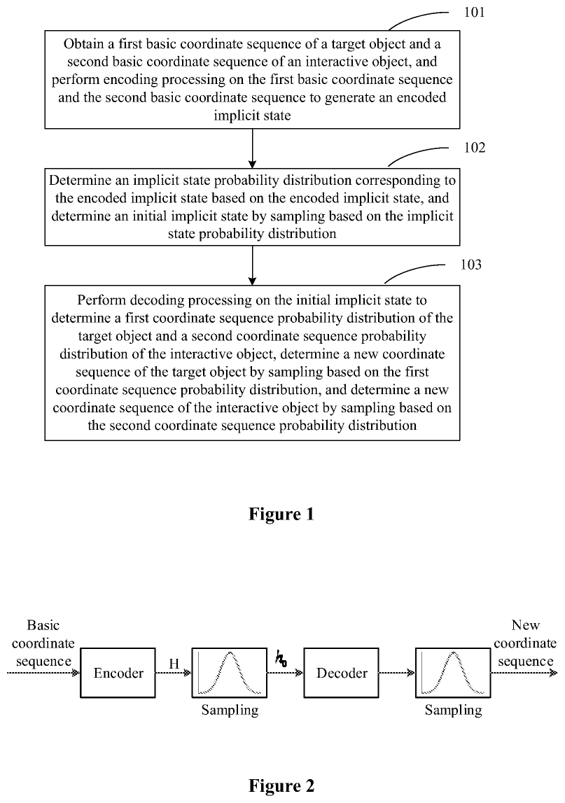

FIG. 1 shows a flowchart of a method for generating an interactive scenario according to an embodiment of the present disclosure. As shown in FIG. 1, the method includes the following steps 101 to 103.

In step 101, a first basic coordinate sequence of a target object and a second basic coordinate sequence of an interactive object are obtained, and encoding processing is performed on the first basic coordinate sequence and the second basic coordinate sequence to generate an encoded implicit state.

In an embodiment of the present disclosure, a target object and an interactive object interacting with the target object exist in an interactive scenario. Specifically, in a vehicle interactive scenario, the target object may be an autonomous vehicle, and the interactive object corresponding to the target object may be a vehicle (such as a vehicle that travels side by side with the autonomous vehicle or an oncoming vehicle) or a pedestrian that interacts with the autonomous vehicle. In addition, there may be one or more target objects in the interactive scenario, and each target object may correspond to one or more interactive objects. In a case that the target object is an autonomous vehicle, only objects surrounding the autonomous vehicle may be considered, that is, the interactive scenario contains an autonomous vehicle and one or more other vehicles interacting with the autonomous vehicle.

The conventional method of generating an interactive scenario generally uses an image of the interactive scenario as an input. In an embodiment of the present disclosure, the essence of extracting the interactive scenario is based on interaction between coordinate sequences generated from the coordinate data of respective objects (including the target object and the interactive object) in the interactive scenario at different time instants, that is, a new interactive scenario is generated based on the coordinate sequences of respective objects.

Specifically, in an embodiment of the present disclosure, a real coordinate sequence of the target object, that is, the first basic coordinate sequence, is determined based on the coordinate data of the target object at different time instants, and the first basic coordinate sequence includes multiple pieces of first coordinate data of the target object at different time instants. In the same way, a real coordinate sequence of the interactive object, that is, the second basic coordinate sequence, may be determined based on the coordinate data of the interactive object at different time instants. The second basic coordinate sequence includes multiple pieces of second coordinate data of the interactive object at different time instants. When the first basic coordinate sequence and the second basic coordinate sequence are determined, the first basic coordinate sequence and the second basic coordinate sequence are encoded, to generate an encoded implicit state. In this embodiment, an encoder may be trained in advance, and the first basic coordinate sequence and the second basic coordinate sequence may be inputted into the trained encoder to perform encoding, thereby generating a corresponding encoded implicit state.

In addition, the first basic coordinate sequence and the second basic coordinate sequence includes the same number of pieces of coordinate data, that is, the number of pieces of the first coordinate data is the same as the number of pieces of the second coordinate data. In an embodiment, the coordinate sequence may be determined based on a trajectory along which the object moves. The first basic coordinate sequence of the target object and the second basic coordinate sequence of the interactive object are obtained in the above step 101 by the following steps A1 and A2.

In step A1, a first trajectory of the target object within a preset time period, and a second trajectory of the interactive object within the preset time period are obtained.

In step A2, the first trajectory and the second trajectory are sampled in a same sampling manner to determine multiple pieces of first coordinate data of multiple position points of the target object and multiple pieces of second coordinate data of multiple position points of the interactive object, the first basic coordinate sequence is generated based on the multiple pieces of first coordinate data, and the second basic coordinate sequence is generated based on the multiple pieces of second coordinate data.

In an embodiment of the present disclosure, objects in a real interactive scenario form corresponding trajectories within a time period. The coordinate data of the trajectories of the target object and the interactive object in the same preset time period may be extracted to generate the coordinate sequences. Specifically, m pieces of coordinate data may be uniformly sampled from each trajectory in a chronological order, that is, m pieces of first coordinate data is sampled from the first trajectory to form the first basic coordinate sequence, and m pieces of second coordinate data is sampled from the second trajectory to form the second basic coordinate sequence. In an embodiment, if the trajectory of the target object and the trajectory of the interactive object correspond to different time periods, the time periods of the two trajectories may be normalized to obtain two trajectories of the same length of time. Then, the coordinate data is extracted. For example, the trajectories of the target object and the interactive object may be normalized to t seconds, s points are uniformly sampled during each second, and a total of t×s points may be sampled, that is, each trajectory may be sampled to obtain t×s pieces of coordinate data.

In step 102, an implicit state probability distribution corresponding to the encoded implicit state is determined based on the encoded implicit state, and an initial implicit state is determined by sampling based on the implicit state probability distribution.

In an embodiment of the present disclosure, the implicit state probability distribution may be a preset form of probability distribution, such as a normal distribution, a uniform distribution, and the like. Based on the encoded implicit state, a parameter of the implicit state probability distribution may be determined, where the parameter is, for example, a mean and a standard deviation of the normal distribution. The implicit state, that is, the initial implicit state, may be randomly obtained by sampling the implicit state probability distribution, and the randomly obtained initial implicit state also conforms to the probability distribution of the encoded implicit state. In this embodiment, the initial implicit state may be determined based on a design principle in a variational auto-encoder (VAE). In an embodiment, the implicit state probability distribution corresponding to the encoded implicit state is determined based on the encoded implicit state in the above step by:

mapping the encoded implicit state into a mean vector μ having a preset dimension and a standard deviation vector σ having a preset dimension, to obtain a multivariate normal distribution N(μ,σ), and constraining a distance between the multivariate normal distribution N(μ,σ) and a standard multivariate normal distribution N(0,I) based on KL divergence, where I represents a unit matrix having the preset dimension.

In an embodiment of the present disclosure, the encoded implicit state may be mapped to a mean vector μ and a standard deviation vector σ based on a pre-trained Multilayer Perceptron (MLP), where each of the mean vector μ and the standard deviation vector σ has the preset dimension. The multivariate normal distribution N(μ,σ) of the real interactive scenario may be represented based on the mean vector μ and the standard deviation vector σ having the preset dimension. In addition, the distance between the multivariate normal distribution N(μ,σ) and the standard multivariate normal distribution N(0,I) is constrained based on the KL divergence, so as to ensure the smoothness of the implicit state value space. I in the standard multivariate normal distribution N(0,I) represents a unit matrix having the preset dimension. For example, if the preset dimension of the mean vector μ and the standard deviation vector σ is N_{z}, I is a unit matrix of N_{z}×N_{z}. The value of the preset dimension may be determined based on experience or determined based on statistics, which is not limited in this embodiment.

Further, the initial implicit state is determined by sampling based on the implicit state probability distribution in the above step by: performing random sampling based on the implicit state probability distribution, to obtain an implicit random vector z, and mapping the implicit random vector z into the initial implicit state h₀ for decoding.

In an embodiment of the present disclosure, random sampling is performed on the implicit state probability distribution N(μ,σ), to obtain the corresponding implicit random vector z by sampling. In addition, another multilayer perceptron may be trained in advance to map the implicit random vector z into the initial implicit state h₀ for decoding.

In step 103, decoding processing is performed on the initial implicit state to determine a first coordinate sequence probability distribution of the target object and a second coordinate sequence probability distribution of the interactive object, a new coordinate sequence of the target object is determined by sampling based on the first coordinate sequence probability distribution, and a new coordinate sequence of the interactive object is determined by sampling based on the second coordinate sequence probability distribution.

In an embodiment of the present disclosure, the coordinates of the object are not directly determined based on the initial implicit state, but the coordinate sequence probability distributions of the target object and the interactive object, that is, the first coordinate sequence probability distribution and the second coordinate sequence probability distribution, are determined by decoding processing, and then the new coordinate sequences of the target object and the interactive object are obtained by sampling. The two new coordinate sequences may respectively represent new moving trajectories of the target object and the interactive object, such that a new interactive scenario can be generated. Similar to the encoder-based encoding process described above, in this embodiment, a decoder may be trained in advance, and the initial implicit state may be inputted to the decoder to generate the first coordinate sequence probability distribution of the target object and the second coordinate sequence probability distribution of the interactive object. Next, the new coordinate sequence of the target object and the new coordinate sequence of the interactive object may be determined by sampling.

Specifically, the model architecture applied in the method for generating an interactive scenario is shown in FIG. 2. The basic coordinate sequences (including the first basic coordinate sequence and the second basic coordinate sequence) extracted from the real interactive scenario is inputted into the encoder, and the encoder outputs the encoded implicit state H. Next, the implicit state probability distribution of the encoded implicit state H is randomly sampled to obtain the initial implicit state h₀, and the initial implicit state h₀ is inputted into the decoder for decoding processing, to determine the coordinate sequence probability distributions of the target object and the interactive object. Then, the new coordinate sequences (including the new coordinate sequence of the target object and the new coordinate sequence of the interactive object) are determined by random sampling.

A method for generating an interactive scenario is provided according to the embodiments of the present disclosure. Basic coordinate sequences extracted from a real interactive scenario are encoded and decoded, to generate new coordinate sequences that simulate real environments. The initial implicit state is determined by performing random sampling on the implicit state probability distribution, and the coordinates of the target object and the interactive object are obtained by performing random sampling on the coordinate sequence probability distribution during the decoding phase. Since random sampling is performed at two stages, generation of interactive scenarios has multiple modalities, and can be used for automatically generating multiple different interactive scenarios for a same map. In addition, during generation of an interactive scenario, the basic coordinate sequence of the object is extracted as input, and the parameters related to the map itself are weakened, such that the method is not limited to a specific map, that is, the method can also be applied to a variety of maps, to generate a variety of interactive scenarios in a variety of maps.

Based on the above embodiment, since the coordinate sequence is a sequence, the encoder may be a single-layer or multi-layer Recurrent Neural Network (RNN), that is, the sequence is encoded based on a recurrent neural network. In an embodiment of the present disclosure, the encoding processing is performed on the first basic coordinate sequence and the second basic coordinate sequence to generate the encoding implicit state in above step 101 by the following steps B1 and B2.

In step B1, multiple pieces of first coordinate data contained in the first basic coordinate sequence are determined, and multiple pieces of second coordinate data contained in the second basic coordinate sequence are determined, where the number of pieces of the first coordinate data is the same as the number of pieces of the second coordinate data.

In step B2, multiple sets of coordinate data are generated based on the first coordinate data and the second coordinate data at same timings, encoding processing is performed by sequentially inputting the multiple sets of coordinate data into a trained recurrent neural network, and the encoded implicit state is generated based on an output of the recurrent neural network.

In an embodiment of the present disclosure, as mentioned above, the two basic coordinate sequences contain the same number of pieces of coordinate data, that is, the number of pieces of the first coordinate data is the same as the number of pieces of the second coordinate data. When performing the encoding processing, first coordinate data and second coordinate data at a same timing are combined to form a set of coordinate data, the multiple sets of coordinate data are sequentially inputted into a recurrent neural network for encoding according to a time sequence. For example, if the first basic coordinate sequence contains three pieces of first coordinate data s1, s2, and s3 arranged in a chronological order, and the second basic coordinate sequence contains three second coordinate data a1, a2, and a3 arranged in a chronological order, s1 and a1 are combined to form a set of coordinate data, s2 and a2 are combined to form a set of coordinate data, and s3 and a3 are combined to form a set of coordinate data. In the vehicle interactive scenario, the coordinate data may be two-dimensional coordinates.

In an embodiment, the recurrent neural network used for encoding may be a bi-directional recurrent neural network. In this embodiment, the recurrent neural network used for encoding includes a Forward Recurrent Neural Network (Forward RNN) and a Backward Recurrent Neural Network (Backward RNN). The encoding processing is performed by sequentially inputting the multiple sets of coordinate data into a trained recurrent neural network, and the encoded implicit state is generated based on an output of the recurrent neural network in the above step B2 by the following steps B21 to B23.

In step B21, the multiple sets of coordinate data are sequentially inputted into the forward recurrent neural network in a chronological order, and a forward implicit state is generated based on an output of the forward recurrent neural network.

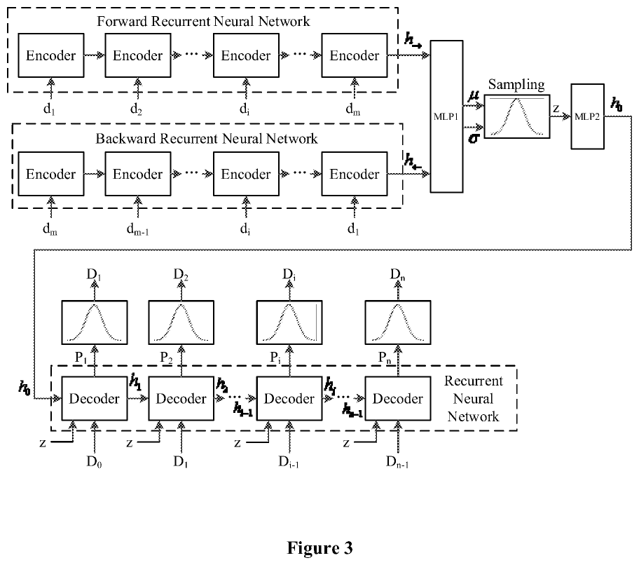

In an embodiment of the present disclosure, the sets of coordinate data are generated in a chronological order, so the sets of coordinate data follow the chronological order. In this embodiment, the sets of coordinate data are sequentially inputted into the forward recurrent neural network in a chronological order, to obtain a corresponding outputted result, that is, the forward implicit state. Referring to FIG. 3, which shows a schematic diagram of the structure of the model architecture developed in the chronological order, the first basic coordinate sequence contains m pieces of first coordinate data, and the second basic coordinate sequence contains m pieces of second coordinate data, and m sets of coordinate data may be correspondingly generated, the m sets of coordinate data includes d₁, d₂, . . . , dₘ, arranged in the chronological order. The m sets of coordinate data d₁, d₂, . . . , dₘ are sequentially used as a step of input of the forward recurrent neural network, to obtain the forward implicit state h_{→} outputted by the forward recurrent neural network.

In step B22, the multiple sets of coordinate data are sequentially inputted into the backward recurrent neural network in a reverse chronological order, and a backward implicit state is generated based on an output of the backward recurrent neural network.

In this embodiment, the “reverse chronological order” indicates an order that is reverse to the chronological order. The m sets of coordinate data in the chronological order are d₁, d₂, . . . , dₘ. The m sets of coordinate data arranged in the reverse chronological order are dₘ, dₘ₋₁, . . . , d₁. As shown in FIG. 3, the sets of coordinate data dₘ, dₘ₋₁, . . . , d₁ are sequentially used as a step of input of the backward recurrent neural network, to obtain the backward implicit state h outputted by the backward recurrent neural network. In FIG. 3, dᵢ represents an i-th set of coordinate data when arranged in the chronological order.

In step B23, the encoded implicit state is generated by combining the forward implicit state and the backward implicit state.

In an embodiment of the present disclosure, the encoded implicit state is generated based on the forward implicit state h_{→} and the backward implicit state h_{←}. In this embodiment, the forward implicit state h_{→} and the backward implicit state h_{←} are combined to obtain the encoded implicit state. For example, each of the forward implicit state h_{→} and the backward implicit state h_{←} is a vector of 128 dimensions, and the forward implicit state h_{→} and the backward implicit state h_{←} are combined to form an encoded implicit state of 256 dimensions. In this embodiment, decoding is sequentially performed based on the forward recurrent neural network and the backward recurrent neural network, such that the characteristics of the coordinate data can be accurately and quickly extracted, thereby generating new coordinate data that effectively simulates real environments.

When the encoded implicit state is determined, the encoded implicit state may be mapped into a mean vector μ and a standard deviation vector σ, and then sampling is performed to obtain the initial implicit state. As shown in FIG. 3, the encoded implicit state is inputted into a first multi-layer perceptron MLP1, which is used to map the encoded implicit state to two vectors of a preset dimension, that is, the mean vector μ and the standard deviation vector σ. The mean vector μ and the standard deviation vector σ may represent a multivariate normal distribution N(μ,σ), which is subsequently randomly sampled to obtain an implicit random vector z. The implicit random vector z is mapped by using a second multilayer perceptron MLP2 to obtain the initial implicit state h₀ for decoding.

Based on the above embodiments, the decoder that performs the decoding processing may also be a single-layer or multi-layer recurrent neural network, which performs decoding on a sequence based on the recurrent neural network. In an embodiment of the present disclosure, the decoder is a Unidirectional Recurrent Neural Network (Unidirectional RNN), and in an i-th step of the decoding process, decoding is performed based on the new coordinate data generated in an (i−1)-th step and the implicit random vector z. In an embodiment, in the above step 103, performing decoding processing on the initial implicit state to determine the first coordinate sequence probability distribution of the target object and the second coordinate sequence probability distribution of the interactive object, determining the new coordinate sequence of the target object by sampling based on the first coordinate sequence probability distribution, and determining the new coordinate sequence of the interactive object by sampling based on the second coordinate sequence probability distribution includes the following steps C1 to C4.

In step C1, decoding processing is performed on an (i−1)th implicit state based on the implicit random vector z and (i−1)th new coordinate data, to determine an i-th implicit state and an i-th coordinate data probability distribution, where the (i−1)th new coordinate data includes (i−1)th new coordinate data of the target object and (i−1)th new coordinate data of the interactive object, and the i-th coordinate data probability distribution includes an i-th first coordinate data probability distribution and an i-th second coordinate data probability distribution, an initial value of the (i−1)th new coordinate data includes preset initial coordinate data of the target object and preset initial coordinate data of the interactive object, and an initial value of the (i−1)th implicit state is the initial implicit state h₀.

In step C2, i-th first new coordinate data of the target object is determined by sampling based on the i-th first coordinate data probability distribution, and i-th second new coordinate data of the interactive object is determined by sampling based on the i-th second coordinate data probability distribution.

In an embodiment of the present disclosure, a previous implicit state is decoded based on the new coordinate data obtained in the previous step and the implicit random vector z. Specifically, as shown in FIG. 3, during the decoding process of the i-th step, the (i−1)th new coordinate data Dᵢ₋₁ and the (i−1)th implicit state hᵢ₋₁ may be obtained in advance, and the (i−1)th implicit state hᵢ₋₁ is decoded based on the implicit random vector z and the (i−1)th new coordinate data Dᵢ₋₁, to generate an i-th implicit state hᵢ and an i-th coordinate data probability distribution Pᵢ, where i-th coordinate data probability distribution Pᵢ includes an i-th first coordinate data probability distribution pᵢ^{s} of the target object and an i-th second coordinate data probability distribution pᵢ^{a} of the interactive object. Next, the i-th first new coordinate data dᵢ^{s} of the target object is determined by sampling based on the i-th first coordinate data probability distribution pᵢ^{s}, and the i-th second new coordinate data dᵢ^{a} of the interactive object is determined by sampling based on the second coordinate data sampling probability distribution pᵢ^{a}. The i-th first new coordinate data dᵢ^{s} and the i-th second new coordinate data dᵢ^{a} are the i-th new coordinate data Di.

In addition, for the decoding process in a 1-th step, zero-th new coordinate data is the preset initial coordinate data D₀, and a zero-th implicit state is the initial implicit state h₀. Specifically, the initial coordinate data D₀ is preset first, and the initial coordinate data D₀ includes initial coordinate data of the target object and initial coordinate data of the interactive object. In an embodiment, the initial coordinate data D₀ may be the initial coordinate data of the two objects in a real interactive scenario, that is, the first coordinate data in the first basic coordinate sequence and the second basic coordinate sequence. Alternatively, the initial coordinate data D₀ may also be a coordinate point set manually, or may be coordinate data automatically generated by other methods, which is not limited in this embodiment. As shown in FIG. 3, in the decoding process of the 1-th step, the initial implicit state h₀ is decoded based on the implicit random vector z and the preset initial coordinate data D₀, to determine the 1-th implicit state h₁ and the 1-th coordinate data probability distribution P₁. The 1-th coordinate data probability distribution P₁ includes the 1-th first coordinate data probability distribution p₁^{s} of the target object and the 1-th second coordinate data probability distribution p₁^{a} of the interactive object. Then, the 1-th first new coordinate data d₁^{s} of the target object is determined by sampling based on the 1-th first coordinate data probability distribution p₁^{s}, and the 1-th second new coordinate data d₁^{a} of the interactive object is determined by sampling based on the 1-th second coordinate data probability distribution p₁^{a}. The 1-th first new coordinate data d₁^{s} and the 1-th second new coordinate data d₁^{a} are the 1-th new coordinate data D₁.

In step C3, i is incremented, and processes of determining the first new coordinate data and the second new coordinate data are repeated, until decoding ends.

In step C4, the new coordinate sequence of the target object is generated based on all of the first new coordinate data, and the new coordinate sequence of the interactive object is generated based on all of the second new coordinate data.

In the embodiments of the present disclosure, the above steps C1 and C2 are performed in each step of the decoding process until the decoding process ends. As shown in FIG. 3, the decoding process ends at the n-th step. In this embodiment, the new coordinate data of each step, that is, D₁, D₂, . . . , Dᵢ, . . . , Dₙ may be sequentially determined through the decoding processing, and the new coordinate data of each step of the target object, that is, the first new coordinate data d₁^{s}, d₂^{s}, . . . , dᵢ^{s}, . . . , dₙ^{a} may be correspondingly determined, so as to generate the new coordinate sequence of the target object. Similarly, the second new coordinate data d₁^{a}, d₂^{a}, . . . , dᵢ^{a}, . . . , dₙ^{a} of the interactive object may be determined, to generate the new coordinate sequence of the interactive object. The number of pieces of the original coordinate data may be the same as the number of pieces of the new coordinate data, that is, m=n in FIG. 3. In this embodiment, the implicit state is decoded based on the implicit random vector z and the new coordinate data from the previous step, such that the implicit random vector z is emphasized at each step in the decoding process, and the synthesized new coordinate data better characterizes the object corresponding to the implicit random vector z during interaction. For example, in the vehicle interactive scenario, the characteristics of the autonomous vehicle and the interactive vehicle corresponding to the implicit random vector z during interaction can be emphasized.

In an embodiment, a Gaussian mixture model (GMM) is used for representing the coordinate data probability distribution. The i-th coordinate data probability distribution is determined in above step C1 by:

determining parameters (μ_{i,k}^{s}, σ_{i,k}^{s}, γ_{i,k}^{s}) of the i-th first coordinate data probability distribution pᵢ^{s} and parameters (μ_{i,k}^{a}, σ_{i,k}^{a}, γ_{i,k}^{a}) of the i-th second coordinate data probability distribution pᵢ^{a}, where the i-th first coordinate data probability distribution and the i-th second coordinate data probability distribution are expressed by:

$${p}_{i}^{s} ( {x}_{s} , {y}_{s} ) = {\sum }_{k = 1}^{K} {π}_{i , k}^{s} N ( {x}_{s} , {y}_{s} \vert {μ}_{i , k}^{s} , {σ}_{i , k}^{s} , {γ}_{i , k}^{s} ) , and$$

$${p}_{i}^{a} ( {x}_{a} , {y}_{a} ) = {\sum }_{k = 1}^{K} {π}_{i , k}^{a} N ( {x}_{a} , {y}_{a} \vert {μ}_{i , k}^{a} , {σ}_{i , k}^{a} , {γ}_{i , k}^{a} ) ,$$

where xₛ, yₛ represents coordinate values of the first coordinate data, xₐ, yₐ represents coordinate values of the second coordinate data, the function N( ) represents a Gaussian distribution density function, π_{i,k}^{s}, μ_{i,k}^{s}, σ_{i,k}^{s}, γ_{i,k}^{s} respectively represent a weight, a mean vector, a standard deviation vector, and a correlation vector of a k-th normal distribution of a Gaussian mixture model of the i-th first coordinate data probability distribution of the target object, π_{i,k}^{a}, μ_{i,k}^{a}, σ_{i,k}^{a}, γ_{i,k}^{a} respectively represent a weight, a mean vector, a standard deviation vector, and a correlation vector of a k-th normal distribution of a Gaussian mixture model of the i-th second coordinate data probability distribution of the interactive object,

$${\sum }_{k = 1}^{K} {π}_{i , k}^{s} = 1 and {\sum }_{k = 1}^{K} {π}_{i , k}^{a} = 1.$$

In the embodiments of the present disclosure, the Gaussian mixture model is used for describing the coordinate data probability distribution pᵢ^{s} of the target object and the coordinate data probability distribution pᵢ^{a} of the interactive object. Specifically, the decoder in the embodiment of the present disclosure performs decoding to generate the parameters of the corresponding Gaussian mixture model, that is, (μ_{i,k}^{s}, σ_{i,k}^{s}, γ_{i,k}^{s}) and (μ_{i,k}^{a}, σ_{i,k}^{a}, γ_{i,k}^{a}) The two sets of parameters respectively represent the coordinate data probability distribution of the target object and the coordinate data probability distribution of the interactive object, that is, the first coordinate data probability distribution and the second coordinate data probability distribution of each step may be respectively determined based on the two sets of parameters. In the embodiment of the present disclosure, in the process of training the overall model formed by the encoder and the decoder, the coordinate sequence extracted from the sample may be used as an input, and the parameters of the corresponding Gaussian mixture model may be used as the output for training. Specifically, training may be performed based on a large amount of relevant data of real interactive scenarios, such that the automatically generated new coordinate data simulates real environments.

A method for generating an interactive scenario is provided according to the embodiments of the present disclosure. Basic coordinate sequences extracted from a real interactive scenario are encoded and decoded, to generate new coordinate sequences that simulate real environments. The initial implicit state is determined by performing random sampling on the implicit state probability distribution, and the coordinates of the target object and the interactive object are obtained by performing random sampling on the coordinate sequence probability distribution during the decoding phase. Since random sampling is performed at two stages, generation of interactive scenarios has multiple modalities, and can be used for automatically generating multiple different interactive scenarios for a same map. In addition, during generation of an interactive scenario, the basic coordinate sequence of the object is extracted as input, and the parameters related to the map itself are weakened, such that the method is not limited to a specific map, that is, the method can also be applied to a variety of maps, to generate a variety of interactive scenarios in a variety of maps. By sequentially performing decoding based on the forward recurrent neural network and the backward recurrent neural network, features of the coordinate data can be extracted more accurately and quickly, such that the generated new coordinate data effectively simulate real environments. The implicit state is decoded based on the implicit random vector z and the new coordinate data from the previous step, such that the implicit random vector z is emphasized at each step in the decoding process, and the synthesized new coordinate data better characterizes the object corresponding to the implicit random vector z during interaction.

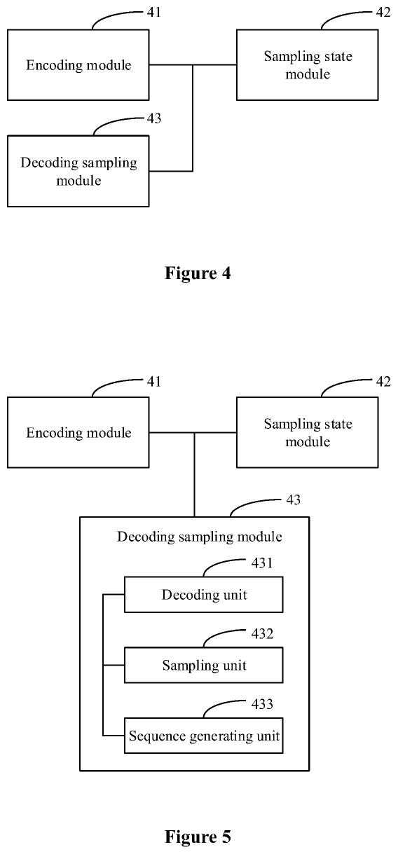

The method for generating an interactive scenario according to an embodiment of the present disclosure is described in detail with reference to FIGS. 1 to 3. The method may be implemented by a corresponding apparatus. In the following, an apparatus for generating an interactive scenario according to an embodiment of the present disclosure is described in detail with reference to FIGS. 4 and 5.

FIG. 4 shows a schematic structural diagram of an apparatus for generating an interactive scenario according to an embodiment of the present disclosure. As shown in FIG. 4, the apparatus for generating an interactive scenario includes an encoding module 41, a sampling state module 42, and a decoding sampling module 43.

The encoding module 41 is configured to obtain a first basic coordinate sequence of a target object and a second basic coordinate sequence of an interactive object, and perform encoding processing on the first basic coordinate sequence and the second basic coordinate sequence to generate an encoded implicit state.

The sampling state module 42 is configured to determine an implicit state probability distribution corresponding to the encoded implicit state based on the encoded implicit state, and determine an initial implicit state by sampling based on the implicit state probability distribution.

The decoding sampling module is configured to perform decoding processing on the initial implicit state to determine a first coordinate sequence probability distribution of the target object and a second coordinate sequence probability distribution of the interactive object, determine a new coordinate sequence of the target object by sampling based on the first coordinate sequence probability distribution, and determine a new coordinate sequence of the interactive object by sampling based on the second coordinate sequence probability distribution.

The apparatus for generating an interactive scenario is provided according to the embodiments of the present disclosure. Basic coordinate sequences extracted from a real interactive scenario are encoded and decoded, to generate new coordinate sequences that simulate real environments. The initial implicit state is determined by performing random sampling on the implicit state probability distribution, and the coordinates of the target object and the interactive object are obtained by performing random sampling on the coordinate sequence probability distribution during the decoding phase. Since random sampling is performed at two stages, generation of interactive scenarios has multiple modalities, and can be used for automatically generating multiple different interactive scenarios for a same map. In addition, during generation of an interactive scenario, the basic coordinate sequence of the object is extracted as input, and the parameters related to the map itself are weakened, such that the apparatus is not limited to a specific map, that is, the apparatus can also be applied to a variety of maps, to generate a variety of interactive scenarios in a variety of maps.

Based on the above embodiment, the encoding module 41 being configured to perform encoding processing on the first basic coordinate sequence and the second basic coordinate sequence to generate the encoded implicit state includes the encoding module 41 being configured to:

determine multiple pieces of first coordinate data contained in the first basic coordinate sequence, and determine multiple pieces of second coordinate data contained in the second basic coordinate sequence, where the number of pieces of the first coordinate data is the same as the number of pieces of the second coordinate data; and

generate multiple sets of coordinate data based on the first coordinate data and the second coordinate data at same timings, perform encoding processing by sequentially inputting the multiple sets of coordinate data into a trained recurrent neural network, and generate the encoded implicit state based on an output of the recurrent neural network.

Based on the above embodiment, the recurrent neural network includes a forward recurrent neural network and a backward recurrent neural network. The encoding module 41 being configured to perform encoding processing by sequentially inputting the multiple sets of coordinate data into the trained recurrent neural network, and generate the encoded implicit state based on the output of the recurrent neural network includes the encoding module 41 being configured to:

sequentially input the multiple sets of coordinate data into the forward recurrent neural network in a chronological order, and generate a forward implicit state based on an output of the forward recurrent neural network,

sequentially input the multiple sets of coordinate data into the backward recurrent neural network in a reverse chronological order, and generate a backward implicit state based on an output of the backward recurrent neural network, and

generate the encoded implicit state by combining the forward implicit state and the backward implicit state.

Based on the above embodiment, the encoding module 41 being configured to obtain the first basic coordinate sequence of the target object and the second basic coordinate sequence of the interactive object includes the encoding module 41 being configured to:

obtain a first trajectory of the target object within a preset time period, and obtain a second trajectory of the interactive object within the preset time period, and

respectively sample the first trajectory and the second trajectory in a same sampling manner to determine multiple pieces of first coordinate data of multiple position points of the target object and multiple pieces of second coordinate data of multiple position points of the interactive object, generate the first basic coordinate sequence based on the multiple pieces of first coordinate data, and generate the second basic coordinate sequence based on the multiple pieces of second coordinate data.

Based on the above embodiment, the sampling state module being configured to determine the implicit state probability distribution corresponding to the encoded implicit state based on the encoded implicit state includes the sampling state module being configured to:

mapping the encoded implicit state into a mean vector μ having a preset dimension and a standard deviation vector σ having the preset dimension, to obtain a multivariate normal distribution N(μ,σ), and constrain a distance between the multivariate normal distribution N(μ,σ) and a standard multivariate normal distribution N(0,I) based on KL divergence, where I represents a unit matrix having the preset dimension.

Based on the above embodiment, the sampling state module 42 being configured to determine the initial implicit state by sampling based on the implicit state probability distribution includes the sampling state module 42 being configured to:

perform random sampling based on the implicit state probability distribution, to obtain an implicit random vector z, and map the implicit random vector z into the initial implicit state h₀ for decoding.

Based on the above embodiment, referring to FIG. 5, the decoding sampling module 43 includes a decoding unit 431, a sampling unit 432, and a sequence generating unit 433.

The decoding unit 431 is configured to perform decoding processing on an (i−1)th implicit state based on the implicit random vector z and (i−1)th new coordinate data to determine an i-th implicit state and an i-th coordinate data probability distribution, where the (i−1)th new coordinate data includes (i−1)th new coordinate data of the target object and (i−1)th new coordinate data of the interactive object, and the i-th coordinate data probability distribution includes an i-th first coordinate data probability distribution and an i-th second coordinate data probability distribution, an initial value of the (i−1)th new coordinate data includes preset initial coordinate data of the target object and preset initial coordinate data of the interactive object, and an initial value of the (i−1)th implicit state is the initial implicit state h₀.

The sampling unit 432 is configured to determine i-th first new coordinate data of the target object by sampling based on the i-th first coordinate data probability distribution, and determine i-th second new coordinate data of the interactive object by sampling based on the i-th second coordinate data probability distribution.

The sequence generating unit 433 is configured to increment i, and repeat processes of determining the first new coordinate data and the second new coordinate data, until decoding ends, generate the new coordinate sequence of the target object based on all of the first new coordinate data, and generate the new coordinate sequence of the interactive object based on all of the second new coordinate data.

Based on the above embodiment, the decoding unit 431 being configured to determine the i-th coordinate data probability distribution includes the decoding unit 431 being configured to:

determining parameters (μ_{i,k}^{s}, σ_{i,k}^{s}, γ_{i,k}^{s}) of the i-th first coordinate data probability distribution pᵢ^{s} and parameters (μ_{i,k}^{a}, σ_{i,k}^{a}, γ_{i,k}^{a}) of the i-th second coordinate data probability distribution pᵢ^{a}, where the i-th first coordinate data probability distribution and the i-th second coordinate data probability distribution are expressed by:

$${p}_{i}^{s} ( {x}_{s} , {y}_{s} ) = {\sum }_{k = 1}^{K} {π}_{i , k}^{s} N ( {x}_{s} , {y}_{s} \vert {μ}_{i , k}^{s} , {σ}_{i , k}^{s} , {γ}_{i , k}^{s} ) , and$$

$${p}_{i}^{a} ( {x}_{a} , {y}_{a} ) = {\sum }_{k = 1}^{K} {π}_{i , k}^{a} N ( {x}_{a} , {y}_{a} \vert {μ}_{i , k}^{a} , {σ}_{i , k}^{a} , {γ}_{i , k}^{a} ) ,$$

where xₛ, yₛ represents coordinate values of the first coordinate data, xₐ, yₐ represents coordinate values of the second coordinate data, the function N( ) represents a Gaussian distribution density function, π_{i,k}^{s}, μ_{i,k}^{s}, σ_{i,k}^{s}, γ_{i,k}^{s} respectively represent a weight, a mean vector, a standard deviation vector, and a correlation vector of a k-th normal distribution of a Gaussian mixture model of the i-th first coordinate data probability distribution of the target object, π_{i,k}^{a}, μ_{i,k}^{a}, σ_{i,k}^{a}, γ_{i,k}^{a} respectively represent a weight, a mean vector, a standard deviation vector, and a correlation vector of a k-th normal distribution of a Gaussian mixture model of the i-th second coordinate data probability distribution of the interactive object,

$${\sum }_{k = 1}^{K} {π}_{i , k}^{s} = 1 and {\sum }_{k = 1}^{K} {π}_{i , k}^{a} = 1.$$

An apparatus for generating an interactive scenario is provided according to the embodiments of the present disclosure. Basic coordinate sequences extracted from a real interactive scenario are encoded and decoded, to generate new coordinate sequences that simulate real environments. The initial implicit state is determined by performing random sampling on the implicit state probability distribution, and the coordinates of the target object and the interactive object are obtained by performing random sampling on the coordinate sequence probability distribution during the decoding phase. Since random sampling is performed at two stages, generation of interactive scenarios has multiple modalities, and can be used for automatically generating multiple different interactive scenarios for a same map. In addition, during generation of an interactive scenario, the basic coordinate sequence of the object is extracted as input, and the parameters related to the map itself are weakened, such that the apparatus is not limited to a specific map, that is, the apparatus can also be applied to a variety of maps, to generate a variety of interactive scenarios in a variety of maps. By sequentially performing decoding based on the forward recurrent neural network and the backward recurrent neural network, features of the coordinate data can be extracted more accurately and quickly, such that the generated new coordinate data effectively simulate real environments. The implicit state is decoded based on the implicit random vector z and the new coordinate data from the previous step, such that the implicit random vector z is emphasized at each step in the decoding process, and the synthesized new coordinate data better characterizes the object corresponding to the implicit random vector z during interaction.

An electronic device is provided according to an embodiment of the present disclosure. The electronic device includes a bus, a transceiver, a memory, a processor, and a computer program stored in the memory and executable by the processor. The transceiver, the memory, and the processor are connected with each other via the bus. The computer program, when executed by the processor, causes the processes of the method for generating an interactive scenario according the embodiments to be performed, and achieves the same technical effect, which is not repeated here for the sake of brevity.

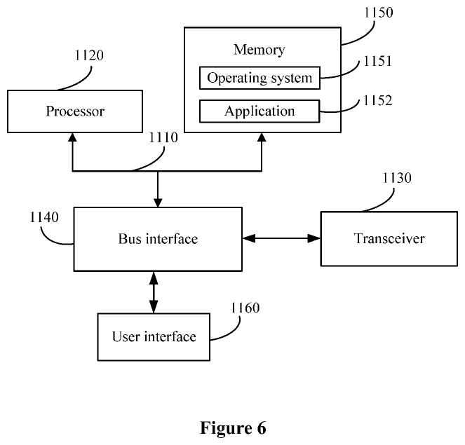

In an embodiment, referring to FIG. 6, an electronic device is further provided. The electronic device includes a bus 1110, a processor 1120, a transceiver 1130, a bus interface 1140, a memory 1150, and a user interface 1160.

In an embodiment of the present disclosure, the electronic device further includes: a computer program stored on the memory 1150 and executable by the processor 1120. The computer program, when executed by the processor 1120, implements the following steps:

obtaining a first basic coordinate sequence of a target object and a second basic coordinate sequence of an interactive object, and performing encoding processing on the first basic coordinate sequence and the second basic coordinate sequence to generate an encoded implicit state;

determining an implicit state probability distribution corresponding to the encoded implicit state based on the encoded implicit state, and determining an initial implicit state by sampling based on the implicit state probability distribution; and

performing decoding processing on the initial implicit state to determine a first coordinate sequence probability distribution of the target object and a second coordinate sequence probability distribution of the interactive object, determining a new coordinate sequence of the target object by sampling based on the first coordinate sequence probability distribution, and determining a new coordinate sequence of the interactive object by sampling based on the second coordinate sequence probability distribution.

In an embodiment, the computer program, when executed by the processor 1120, implementing the step of performing encoding processing on the first basic coordinate sequence and the second basic coordinate sequence to generate the encoded implicit state, includes the computer program causing the processor to implements the following steps:

determining multiple pieces of first coordinate data contained in the first basic coordinate sequence, and determining multiple pieces of second coordinate data contained in the second basic coordinate sequence, where the number of pieces of the first coordinate data is the same as the number of pieces of the second coordinate data; and

generating multiple sets of coordinate data based on the first coordinate data and the second coordinate data at same timings, performing encoding processing by sequentially inputting the multiple sets of coordinate data into a trained recurrent neural network, and generating the encoded implicit state based on an output of the recurrent neural network.

In an embodiment, the computer program, when executed by the processor 1120, implementing the step of performing encoding processing by sequentially inputting the plurality of sets of coordinate data into the trained recurrent neural network, and generating the encoded implicit state based on the output of the recurrent neural network includes the computer program causing the processor to implements the following steps:

sequentially inputting the multiple sets of coordinate data into the forward recurrent neural network in a chronological order, and generating a forward implicit state based on an output of the forward recurrent neural network,

sequentially inputting the multiple sets of coordinate data into the backward recurrent neural network in a reverse chronological order, and generating a backward implicit state based on an output of the backward recurrent neural network, and

generating the encoded implicit state by combining the forward implicit state and the backward implicit state.

In an embodiment, the computer program, when executed by the processor 1120, implementing the step of obtaining the first basic coordinate sequence of the target object and the second basic coordinate sequence of the interactive object includes the computer program causing the processor to implements the following steps:

obtaining a first trajectory of the target object within a preset time period, and obtaining a second trajectory of the interactive object within the preset time period, and

respectively sampling the first trajectory and the second trajectory in a same sampling manner to determine multiple pieces of first coordinate data of multiple position points of the target object and multiple pieces of second coordinate data of multiple position points of the interactive object, generating the first basic coordinate sequence based on the multiple pieces of first coordinate data, and generating the second basic coordinate sequence based on the multiple pieces of second coordinate data.

In an embodiment, the computer program, when executed by the processor 1120, implementing the step of determining the implicit state probability distribution corresponding to the encoded implicit state based on the encoded implicit state includes the computer program causing the processor to implements the following step:

mapping the encoded implicit state into a mean vector μ having a preset dimension and a standard deviation vector σ having the preset dimension, to obtain a multivariate normal distribution N(μ,σ), and constraining a distance between the multivariate normal distribution N(μ,σ) and a standard multivariate normal distribution N(0,I) based on KL divergence, where I represents a unit matrix having the preset dimension.

In an embodiment, the computer program, when executed by the processor 1120, implementing the step of determining the initial implicit state by sampling based on the implicit state probability distribution includes the computer program causing the processor to implements the following step:

performing random sampling based on the implicit state probability distribution, to obtain an implicit random vector z, and mapping the implicit random vector z into the initial implicit state h₀ for decoding.

In an embodiment, the computer program, when executed by the processor 1120, implementing the step of performing decoding processing on the initial implicit state to determine the first coordinate sequence probability distribution of the target object and the second coordinate sequence probability distribution of the interactive object, determining the new coordinate sequence of the target object by sampling based on the first coordinate sequence probability distribution, and determining the new coordinate sequence of the interactive object by sampling based on the second coordinate sequence probability distribution includes the computer program causing the processor to implements the following steps:

performing decoding processing on an (i−1)th implicit state based on the implicit random vector z and (i−1)th new coordinate data to determine an i-th implicit state and an i-th coordinate data probability distribution, where the (i−1)th new coordinate data includes (i−1)th new coordinate data of the target object and (i−1)th new coordinate data of the interactive object, and the i-th coordinate data probability distribution includes an i-th first coordinate data probability distribution and an i-th second coordinate data probability distribution, an initial value of the (i−1)th new coordinate data includes preset initial coordinate data of the target object and preset initial coordinate data of the interactive object, and an initial value of the (i−1)th implicit state is the initial implicit state h₀;

determine i-th first new coordinate data of the target object by sampling based on the i-th first coordinate data probability distribution, and determine i-th second new coordinate data of the interactive object by sampling based on the i-th second coordinate data probability distribution;

incrementing i, and repeating processes of determining the first new coordinate data and the second new coordinate data, until decoding ends; and

generating the new coordinate sequence of the target object based on all of the first new coordinate data, and generating the new coordinate sequence of the interactive object based on all of the second new coordinate data.

In an embodiment, the computer program, when executed by the processor 1120, implementing the step of determining the i-th coordinate data probability distribution includes the computer program causing the processor to implements the following steps:

determining parameters (μ_{i,k}^{s}, σ_{i,k}^{s}, γ_{i,k}^{s}) of the i-th first coordinate data probability distribution pᵢ^{s} and parameters (μ_{i,k}^{a}, σ_{i,k}^{a}, γ_{i,k}^{a}) of the i-th second coordinate data probability distribution pᵢ^{a}, where the i-th first coordinate data probability distribution and the i-th second coordinate data probability distribution are expressed by:

$${p}_{i}^{s} ( {x}_{s} , {y}_{s} ) = {\sum }_{k = 1}^{K} {π}_{i , k}^{s} N ( {x}_{s} , {y}_{s} \vert {μ}_{i , k}^{s} , {σ}_{i , k}^{s} , {γ}_{i , k}^{s} ) , and$$

$${p}_{i}^{a} ( {x}_{a} , {y}_{a} ) = {\sum }_{k = 1}^{K} {π}_{i , k}^{a} N ( {x}_{a} , {y}_{a} \vert {μ}_{i , k}^{a} , {σ}_{i , k}^{a} , {γ}_{i , k}^{a} ) ,$$

where xₛ, yₛ represents coordinate values of the first coordinate data, xₐ, yₐ represents coordinate values of the second coordinate data, the function N( ) represents a Gaussian distribution density function, π_{i,k}^{s}, μ_{i,k}^{s}, σ_{i,k}^{s}, γ_{i,k}^{s} respectively represent a weight, a mean vector, a standard deviation vector, and a correlation vector of a k-th normal distribution of a Gaussian mixture model of the i-th first coordinate data probability distribution of the target object, π_{i,k}^{a}, μ_{i,k}^{a}, σ_{i,k}^{a}, γ_{i,k}^{a} respectively represent a weight, a mean vector, a standard deviation vector, and a correlation vector of a k-th normal distribution of a Gaussian mixture model of the i-th second coordinate data probability distribution of the interactive object,

$${\sum }_{k = 1}^{K} {π}_{i , k}^{s} = 1 and {\sum }_{k = 1}^{K} {π}_{i , k}^{a} = 1.$$

The transceiver 1130 is configured to receive and send data under control of the processor 1120.

In an embodiment of the present disclosure, a bus architecture is represented by a bus 1110. The bus 1110 may include any number of interconnected buses and bridges, and the bus 1110 connects circuitry of one or more processors represented by the processor 1120 and a memory represented by the memory 1150 with each other.

The bus 1110 represents one or more of any one of several types of bus structures, including a memory bus and a memory controller, a peripheral bus, an Accelerate Graphical Port (AGP), a processor, or a local bus of any bus structure in various bus architectures. By way of example and not limitation, such architectures include: Industry Standard Architecture (ISA) bus, Micro Channel Architecture (MCA) bus, Extended ISA (Enhanced ISA, EISA) bus, Video Electronics Standard Association (VESA) bus, and Peripheral Component Interconnect (PCI) bus.

The processor 1120 may be an integrated circuit chip with signal processing capabilities. In the implementation process, the steps of the foregoing method embodiments may be implemented by an integrated logic circuit in the form of hardware in the processor or instructions in the form of software. The above processors include: a general-purpose processor, a Central Processing Unit (CPU), a Network Processor (NP), a Digital Signal Processor (DSP), an Application Specific Integrated Circuit (ASIC), a Field Programmable Gate Array (FPGA), a Complex Programmable Logic Device (CPLD), a Programmable Logic Array (PLA), a Microcontroller Unit (MCU), or other programmable logic devices, discrete gates, transistor logic devices, discrete hardware components, for implementing or executing the methods, steps, and logical block diagrams disclosed in the embodiments of the present disclosure. For example, the processor may be a single-core processor or a multi-core processor, and the processor may be integrated into a single chip or located on multiple different chips.

The processor 1120 may be a microprocessor or any conventional processor. The method steps disclosed in conjunction with the embodiments of the present disclosure may be directly performed by a hardware decoding processor, or may be performed by a combination of hardware in the decoding processor and software modules. The software modules may be located in a Random Access Memory (RAM), a Flash Memory (Flash Memory), a Read-Only Memory (ROM), a Programmable Read Only Memory (Programmable ROM, PROM), an erasable and removable Programming read-only memory (Erasable PROM, EPROM), registers and other readable storage mediums known in the art. The readable storage medium is located in the memory, and the processor reads the information in the memory and implements the steps of the above method in combination with its hardware.

The bus 1110 may also connect various other circuits such as peripheral devices, voltage regulators, or power management circuits with each other. The bus interface 1140 provides an interface between the bus 1110 and the transceiver 1130, which are well known in the art. Therefore, it will not be further described in the embodiments of the present disclosure.

The transceiver 1130 may be one element or multiple elements, such as multiple receivers and transmitters, providing a unit for communicating with various other devices on a transmission medium. For example, the transceiver 1130 receives external data from other devices, and the transceiver 1130 is configured to send the data processed by the processor 1120 to other devices. Depending on the nature of the computer system, a user interface 1160 may also be provided, which includes, for example: a touch screen, a physical keyboard, a display, a mouse, a speaker, a microphone, a trackball, a joystick, and a stylus.

It should be understood that, in the embodiments of the present disclosure, the memory 1150 may further include memories set remotely with respect to the processor 1120, and these remotely set memories may be connected to the server through a network. One or more parts of the above network may be an ad hoc network, an intranet, an extranet, a Virtual Private Network (VPN), a Local Area Network (LAN), a Wireless Local Area Network (WLAN), a Wide Area Network (WAN), a Wireless Wide Area Network (WWAN), a Metropolitan Area Network (MAN), the Internet, a Public Switched Telephone Network (PSTN), a Plain Old Telephone Service Network (POTS), a Cellular Telephone Network, a wireless network, a Wireless Fidelity (Wi-Fi) network and a combination of two or more of the above networks. For example, the cellular telephone network and the wireless network may be a Global Mobile Communication (GSM) system, a Code Division Multiple Access (CDMA) system, a Global Microwave Interconnected Access (WiMAX) system, a General Packet Radio Service (GPRS) system, and a Wideband Code Division Multiple Address (WCDMA) system, a Long Term Evolution (LTE) system, an LTE Frequency Division Duplex (FDD) system, an LTE Time Division Duplex (TDD) system, an advanced long term evolution (LTE-A) system, an Universal Mobile Telecommunications (UMTS) system, an Enhanced Mobile Broadband (eMBB) system, a mass Machine Type of Communication (mMTC) system, an ultra Reliable Low Latency Communications (uRLLC) system, and the like.

It should be understood that the memory 1150 in the embodiments of the present disclosure may be a volatile memory or a non-volatile memory, or may include both a volatile memory and a non-volatile memory. The non-volatile memory includes: a Read-Only Memory (ROM), a Programmable Read-Only Memory (Programmable ROM, PROM), an Erasable Programmable Read-Only Memory (Erasable PROM, EPROM), an Electronically Erasable Programmable Read Only Memory (Electrically EPROM, EEPROM) or a Flash Memory (Flash Memory).

The volatile memory includes: a Random Access Memory (RAM), which is used as an external cache. By way of example but not limitation, many forms of RAM may be used, such as: a Static Random Access Memory (Static RAM, SRAM), a Dynamic Random Access Memory (Dynamic RAM, DRAM), a Synchronous Dynamic Random Access Memory (Synchronous DRAM, SDRAM), a Double Data Rate Synchronous Dynamic Random Access Memory (Double Data Rate SDRAM, DDRSDRAM), an Enhanced Synchronous Dynamic Random Access Memory (Enhanced SDRAM, ESDRAM), a Synchronous Linked Dynamic Random Access Memory (Synchlink DRAM, SLDRAM), and a direct memory bus random access memory (Direct Rambus RAM, DRRAM). The memory 1150 of the electronic device described in the embodiments of the present disclosure includes but is not limited to the above and any other suitable types of memories.

In the embodiments of the present disclosure, the memory 1150 stores the following elements of the operating system 1151 and the application 1152: executable modules, data structures, a subset of the executable modules and the structures, or an extended set of the executable modules and the structures.

Specifically, the operating system 1151 includes various system programs, such as a framework layer, a core library layer, a driver layer, and the like, for implementing various basic services and processing hardware-based tasks. The application 1152 includes various applications, such as a Media Player and a Browser, which are used to implement various application services. The program for implementing the method of the embodiment of the present disclosure may be included in the application 1152. The application 1152 include: applets, objects, components, logic, data structures, and other computer system executable instructions that perform specific tasks or implement specific abstract data types.

In addition, a computer-readable storage medium on which a computer program is stored is further provided according to an embodiment of the present disclosure. The computer program, when executed by a processor, causes the processes of the method for generating an interactive scenario according the embodiments to be performed, and achieves the same technical effect, which is not repeated here for the sake of brevity.

The computer program, when executed by a processor, implements the following steps:

obtaining a first basic coordinate sequence of a target object and a second basic coordinate sequence of an interactive object, and performing encoding processing on the first basic coordinate sequence and the second basic coordinate sequence to generate an encoded implicit state;

determining an implicit state probability distribution corresponding to the encoded implicit state based on the encoded implicit state, and determining an initial implicit state by sampling based on the implicit state probability distribution; and

performing decoding processing on the initial implicit state to determine a first coordinate sequence probability distribution of the target object and a second coordinate sequence probability distribution of the interactive object, determining a new coordinate sequence of the target object by sampling based on the first coordinate sequence probability distribution, and determining a new coordinate sequence of the interactive object by sampling based on the second coordinate sequence probability distribution.

In an embodiment, the computer program, when executed by the processor 1120, implementing the step of performing encoding processing on the first basic coordinate sequence and the second basic coordinate sequence to generate the encoded implicit state, includes the computer program causing the processor to implements the following steps:

determining multiple pieces of first coordinate data contained in the first basic coordinate sequence, and determining multiple pieces of second coordinate data contained in the second basic coordinate sequence, where the number of pieces of the first coordinate data is the same as the number of pieces of the second coordinate data; and

generating multiple sets of coordinate data based on the first coordinate data and the second coordinate data at same timings, performing encoding processing by sequentially inputting the multiple sets of coordinate data into a trained recurrent neural network, and generating the encoded implicit state based on an output of the recurrent neural network.

In an embodiment, the computer program, when executed by the processor 1120, implementing the step of performing encoding processing by sequentially inputting the multiple sets of coordinate data into the trained recurrent neural network, and generating the encoded implicit state based on the output of the recurrent neural network includes the computer program causing the processor to implements the following steps:

sequentially inputting the multiple sets of coordinate data into the forward recurrent neural network in a chronological order, and generating a forward implicit state based on an output of the forward recurrent neural network,

sequentially inputting the multiple sets of coordinate data into the backward recurrent neural network in a reverse chronological order, and generating a backward implicit state based on an output of the backward recurrent neural network, and

generating the encoded implicit state by combining the forward implicit state and the backward implicit state.

In an embodiment, the computer program, when executed by the processor 1120, implementing the step of obtaining the first basic coordinate sequence of the target object and the second basic coordinate sequence of the interactive object includes the computer program causing the processor to implements the following steps:

obtaining a first trajectory of the target object within a preset time period, and obtaining a second trajectory of the interactive object within the preset time period, and

respectively sampling the first trajectory and the second trajectory in a same sampling manner to determine multiple pieces of first coordinate data of multiple position points of the target object and multiple pieces of second coordinate data of multiple position points of the interactive object, generating the first basic coordinate sequence based on the multiple pieces of first coordinate data, and generating the second basic coordinate sequence based on the multiple pieces of second coordinate data.

In an embodiment, the computer program, when executed by the processor 1120, implementing the step of determining the implicit state probability distribution corresponding to the encoded implicit state based on the encoded implicit state includes the computer program causing the processor to implements the following step:

mapping the encoded implicit state into a mean vector μ having a preset dimension and a standard deviation vector σ having the preset dimension, to obtain a multivariate normal distribution N(μ,σ), and constraining a distance between the multivariate normal distribution N(μ,σ) and a standard multivariate normal distribution N(0,I) based on KL divergence, where I represents a unit matrix having the preset dimension.

In an embodiment, the computer program, when executed by the processor 1120, implementing the step of determining the initial implicit state by sampling based on the implicit state probability distribution includes the computer program causing the processor to implements the following step:

performing random sampling based on the implicit state probability distribution, to obtain an implicit random vector z, and mapping the implicit random vector z into the initial implicit state h₀ for decoding.

In an embodiment, the computer program, when executed by the processor 1120, implementing the step of performing decoding processing on the initial implicit state to determine the first coordinate sequence probability distribution of the target object and the second coordinate sequence probability distribution of the interactive object, determining the new coordinate sequence of the target object by sampling based on the first coordinate sequence probability distribution, and determining the new coordinate sequence of the interactive object by sampling based on the second coordinate sequence probability distribution includes the computer program causing the processor to implements the following steps:

performing decoding processing on an (i−1)th implicit state based on the implicit random vector z and (i−1)th new coordinate data to determine an i-th implicit state and an i-th coordinate data probability distribution, where the (i−1)th new coordinate data includes (i−1)th new coordinate data of the target object and (i−1)th new coordinate data of the interactive object, and the i-th coordinate data probability distribution includes an i-th first coordinate data probability distribution and an i-th second coordinate data probability distribution, an initial value of the (i−1)th new coordinate data includes preset initial coordinate data of the target object and preset initial coordinate data of the interactive object, and an initial value of the (i−1)th implicit state is the initial implicit state h₀;

determine i-th first new coordinate data of the target object by sampling based on the i-th first coordinate data probability distribution, and determine i-th second new coordinate data of the interactive object by sampling based on the i-th second coordinate data probability distribution;

incrementing i, and repeating processes of determining the first new coordinate data and the second new coordinate data, until decoding ends; and

generating the new coordinate sequence of the target object based on all of the first new coordinate data, and generating the new coordinate sequence of the interactive object based on all of the second new coordinate data.

In an embodiment, the computer program, when executed by the processor 1120, implementing the step of determining the i-th coordinate data probability distribution includes the computer program causing the processor to implements the following steps:

determining parameters (μ_{i,k}^{s}, σ_{i,k}^{s}, γ_{i,k}^{s}) of the i-th first coordinate data probability distribution pᵢ^{s} and parameters (μ_{i,k}^{a}, σ_{i,k}^{a}, γ_{i,k}^{a}) of the i-th second coordinate data probability distribution pᵢ^{a}, where the i-th first coordinate data probability distribution and the i-th second coordinate data probability distribution are expressed by:

$${p}_{i}^{s} ( {x}_{s} , {y}_{s} ) = {\sum }_{k = 1}^{K} {π}_{i , k}^{s} N ( {x}_{s} , {y}_{s} \vert {μ}_{i , k}^{s} , {σ}_{i , k}^{s} , {γ}_{i , k}^{s} ) , and$$

$${p}_{i}^{a} ( {x}_{a} , {y}_{a} ) = {\sum }_{k = 1}^{K} {π}_{i , k}^{a} N ( {x}_{a} , {y}_{a} \vert {μ}_{i , k}^{a} , {σ}_{i , k}^{a} , {γ}_{i , k}^{a} ) ,$$

where xₛ, yₛ represents coordinate values of the first coordinate data, xₐ, yₐ represents coordinate values of the second coordinate data, the function N( ) represents a Gaussian distribution density function, π_{i,k}^{s}, μ_{i,k}^{s}, σ_{i,k}^{s}, γ_{i,k}^{s} respectively represent a weight, a mean vector, a standard deviation vector, and a correlation vector of a k-th normal distribution of a Gaussian mixture model of the i-th first coordinate data probability distribution of the target object, π_{i,k}^{a}, μ_{i,k}^{a}, σ_{i,k}^{a}, γ_{i,k}^{a} respectively represent a weight, a mean vector, a standard deviation vector, and a correlation vector of a k-th normal distribution of a Gaussian mixture model of the i-th second coordinate data probability distribution of the interactive object,

$${\sum }_{k = 1}^{K} {π}_{i , k}^{s} = 1 and {\sum }_{k = 1}^{K} {π}_{i , k}^{a} = 1.$$

The computer-readable storage medium includes: permanent and non-permanent, removable and non-removable mediums, and is a tangible device that is capable of retaining and storing instructions for use by instruction execution devices. The computer-readable storage medium includes: an electronic storage device, a magnetic storage device, an optical storage device, an electromagnetic storage device, a semiconductor storage device, and any suitable combination of the foregoing. The computer readable storage medium includes: a Phase Change Memory (PRAM), a Static Random Access Memory (SRAM), a Dynamic Random Access Memory (DRAM), other types of Random Access Memories (RAM), a Read Only Memory (ROM), a Non-Volatile Random Access Memory (NVRAM), an Electrically Erasable Programmable Read-Only Memory (EEPROM), a flash memory or another memory technology, a Compact Disc Read-Only Memory (CD-ROM), a Digital Versatile Disc (DVD) or another optical storage, a magnetic cassette storage, a magnetic tape storage or another magnetic storage device, a memory stick, a mechanical coding device (such as a punched card or raised structures in grooves on which instructions are recorded) or any other non-transmission medium that can be used to store information that may be accessed by computing devices. According to the definition in the embodiments of the present disclosure, the computer-readable storage medium does not include the temporary signal itself, such as radio waves or other freely propagating electromagnetic waves, electromagnetic waves propagating through waveguides or other transmission media (such as optical pulses passing through fiber optic cables), or electrical signals transmitted through wires.

In the embodiments according to the present application, it should be understood that the disclosed apparatus, electronic device and method may be implemented in other ways. For example, the apparatus embodiments described above are only schematic. For example, the units or modules are divided based on a logic function thereof, and they may be divided in another way in practice. For example, multiple units or modules may be combined or integrated into another system, or some features may be omitted or not performed. In addition, a coupling, a direct coupling or a communication connection between displayed or discussed constitutional components may be an indirect coupling or a communication connection via some interfaces, devices or modules, and may be in an electrical form, a mechanical form or another form.

The units illustrated as separate components may be or may not be separated physically, and the component displayed as a unit may be or may not be a physical unit. That is, the components may be located at the same place, or may be distributed on multiple network units, and some of or all of the units can be selected, as required, to solve the problem solved by the solution according to the embodiments of the present disclosure.

In addition, each function unit according to each embodiment of the present disclosure may be integrated into one processing unit, or may be a separate unit physically, or two or more units are integrated into one unit. The integrated unit described above may be realized in a hardware way, or may be realized by a software function unit.

The integrated unit may be stored in a computer readable storage medium if the integrated unit is implemented in a software function unit and sold or used as a separate product. Base on such understanding, the essential part of the technical solution of the present application or the part of the technical solution of the present application contributed to the conventional technology or all of or a part of the technical solution may be embodied in a software product way. The computer software product is stored in a storage medium, which includes several instructions to make a computer device (may be a personal computer, a server, a network device or the like) execute all or a part of steps of the method according to each embodiment of the present application. The storage medium described above includes various mediums listed above which can store program codes.

Specific embodiments of the present disclosure are disclosed as described above, but the scope of protection of the present disclosure is not limited thereto. Changes and alteration which may be thought in the technical scope disclosed by the present disclosure by one skilled in the art should fall within the scope of protection of the present disclosure. Therefore, the scope of protection of the present disclosure should be defined by the appended claims.

1. A method for generating an interactive scenario, comprising:
obtaining a first basic coordinate sequence of a target object and a second basic coordinate sequence of an interactive object, and performing encoding processing on the first basic coordinate sequence and the second basic coordinate sequence to generate an encoded implicit state;
determining an implicit state probability distribution corresponding to the encoded implicit state based on the encoded implicit state, and determining an initial implicit state by sampling based on the implicit state probability distribution; and
performing decoding processing on the initial implicit state to determine a first coordinate sequence probability distribution of the target object and a second coordinate sequence probability distribution of the interactive object, determining a new coordinate sequence of the target object by sampling based on the first coordinate sequence probability distribution, and determining a new coordinate sequence of the interactive object by sampling based on the second coordinate sequence probability distribution.

2. The method according to claim 1, wherein the performing encoding processing on the first basic coordinate sequence and the second basic coordinate sequence to generate the encoded implicit state comprises:
determining a plurality of pieces of first coordinate data contained in the first basic coordinate sequence, and determining a plurality of pieces of second coordinate data contained in the second basic coordinate sequence, wherein the number of pieces of the first coordinate data is the same as the number of pieces of the second coordinate data; and
generating a plurality of sets of coordinate data based on the first coordinate data and the second coordinate data at same timings, performing encoding processing by sequentially inputting the plurality of sets of coordinate data into a trained recurrent neural network, and generating the encoded implicit state based on an output of the recurrent neural network.

3. The method according to claim 2, wherein the recurrent neural network comprises a forward recurrent neural network and a backward recurrent neural network, and
the performing encoding processing by sequentially inputting the plurality of sets of coordinate data into the trained recurrent neural network, and generating the encoded implicit state based on the output of the recurrent neural network comprises:
sequentially inputting the plurality of sets of coordinate data into the forward recurrent neural network in a chronological order, and generating a forward implicit state based on an output of the forward recurrent neural network,
sequentially inputting the plurality of sets of coordinate data into the backward recurrent neural network in a reverse chronological order, and generating a backward implicit state based on an output of the backward recurrent neural network, and
generating the encoded implicit state by combining the forward implicit state and the backward implicit state.

4. The method according to claim 1, wherein the obtaining the first basic coordinate sequence of the target object and the second basic coordinate sequence of the interactive object comprises:
obtaining a first trajectory of the target object within a preset time period, and obtaining a second trajectory of the interactive object within the preset time period, and
respectively sampling the first trajectory and the second trajectory in a same sampling manner to determine a plurality of pieces of first coordinate data of a plurality of position points of the target object and a plurality of pieces of second coordinate data of a plurality of position points of the interactive object, generating the first basic coordinate sequence based on the plurality of pieces of first coordinate data, and generating the second basic coordinate sequence based on the plurality of pieces of second coordinate data.

5. The method according to claim 1, wherein the determining the implicit state probability distribution corresponding to the encoded implicit state based on the encoded implicit state comprises:
mapping the encoded implicit state into a mean vector μ having a preset dimension and a standard deviation vector σ having the preset dimension, to obtain a multivariate normal distribution N(μ,σ), and constraining a distance between the multivariate normal distribution N(μ,σ) and a standard multivariate normal distribution N(0,I) based on KL divergence, wherein I represents a unit matrix having the preset dimension.

6. The method according to claim 1, wherein the determining the initial implicit state by sampling based on the implicit state probability distribution comprises:
performing random sampling based on the implicit state probability distribution, to obtain an implicit random vector z, and mapping the implicit random vector z into the initial implicit state h₀ for decoding.

7. The method according to claim 6, wherein the performing decoding processing on the initial implicit state to determine the first coordinate sequence probability distribution of the target object and the second coordinate sequence probability distribution of the interactive object, determining the new coordinate sequence of the target object by sampling based on the first coordinate sequence probability distribution, and determining the new coordinate sequence of the interactive object by sampling based on the second coordinate sequence probability distribution comprises:
performing decoding processing on an (i−1)th implicit state based on the implicit random vector z and (i−1)th new coordinate data to determine an i-th implicit state and an i-th coordinate data probability distribution, wherein the (i−1)th new coordinate data comprises (i−1)th new coordinate data of the target object and (i−1)th new coordinate data of the interactive object, and the i-th coordinate data probability distribution comprises an i-th first coordinate data probability distribution and an i-th second coordinate data probability distribution, an initial value of the (i−1)th new coordinate data comprises preset initial coordinate data of the target object and preset initial coordinate data of the interactive object, and an initial value of the (i−1)th implicit state is the initial implicit state h₀;
determining i-th first new coordinate data of the target object by sampling based on the i-th first coordinate data probability distribution, and determining i-th second new coordinate data of the interactive object by sampling based on the i-th second coordinate data probability distribution;
incrementing i, and repeating processes of determining the first new coordinate data and the second new coordinate data, until decoding ends; and
generating the new coordinate sequence of the target object based on all of the first new coordinate data, and generating the new coordinate sequence of the interactive object based on all of the second new coordinate data.

8. The method according to claim 7, wherein determining the i-th coordinate data probability distribution comprises:
determining parameters (μ_{i,k}^{s}, σ_{i,k}^{s}, γ_{i,k}^{s}) of the i-th first coordinate data probability distribution pᵢ^{s} and parameters (μ_{i,k}^{a}, σ_{i,k}^{a}, γ_{i,k}^{a}) of the i-th second coordinate data probability distribution pᵢ^{a}, where the i-th first coordinate data probability distribution and the i-th second coordinate data probability distribution are expressed by:
$${p}_{i}^{s} ( {x}_{s} , {y}_{s} ) = {\sum }_{k = 1}^{K} {π}_{i , k}^{s} N ( {x}_{s} , {y}_{s} \vert {μ}_{i , k}^{s} , {σ}_{i , k}^{s} , {γ}_{i , k}^{s} ) , and$$
$${p}_{i}^{a} ( {x}_{a} , {y}_{a} ) = {\sum }_{k = 1}^{K} {π}_{i , k}^{a} N ( {x}_{a} , {y}_{a} \vert {μ}_{i , k}^{a} , {σ}_{i , k}^{a} , {γ}_{i , k}^{a} ) ,$$
where xₛ, yₛ represents coordinate values of the first coordinate data, xₐ, yₐ represents coordinate values of the second coordinate data, the function N( ) represents a Gaussian distribution density function, π_{i,k}^{s}, μ_{i,k}^{s}, σ_{i,k}^{s}, γ_{i,k}^{s} respectively represent a weight, a mean vector, a standard deviation vector, and a correlation vector of a k-th normal distribution of a Gaussian mixture model of the i-th first coordinate data probability distribution of the target object, π_{i,k}^{a}, μ_{i,k}^{a}, σ_{i,k}^{a}, γ_{i,k}^{a} respectively represent a weight, a mean vector, a standard deviation vector, and a correlation vector of a k-th normal distribution of a Gaussian mixture model of the i-th second coordinate data probability distribution of the interactive object,
$${\sum }_{k = 1}^{K} {π}_{i , k}^{s} = 1 and {\sum }_{k = 1}^{K} {π}_{i , k}^{a} = 1.$$

9. An apparatus for generating an interactive scenario, comprising:
an encoding module configured to obtain a first basic coordinate sequence of a target object and a second basic coordinate sequence of an interactive object, and perform encoding processing on the first basic coordinate sequence and the second basic coordinate sequence to generate an encoded implicit state;
a sampling state module configured to determine an implicit state probability distribution corresponding to the encoded implicit state based on the encoded implicit state, and determine an initial implicit state by sampling based on the implicit state probability distribution; and
a decoding sampling module configured to perform decoding processing on the initial implicit state to determine a first coordinate sequence probability distribution of the target object and a second coordinate sequence probability distribution of the interactive object, determine a new coordinate sequence of the target object by sampling based on the first coordinate sequence probability distribution, and determine a new coordinate sequence of the interactive object by sampling based on the second coordinate sequence probability distribution.

10. The apparatus according to claim 9, wherein the encoding module being configured to perform encoding processing on the first basic coordinate sequence and the second basic coordinate sequence to generate the encoded implicit state comprises the encoding module being configured to:
determine a plurality of pieces of first coordinate data contained in the first basic coordinate sequence, and determine a plurality of pieces of second coordinate data contained in the second basic coordinate sequence, wherein the number of pieces of the first coordinate data is the same as the number of pieces of the second coordinate data; and
generate a plurality of sets of coordinate data based on the first coordinate data and the second coordinate data at same timings, perform encoding processing by sequentially inputting the plurality of sets of coordinate data into a trained recurrent neural network, and generate the encoded implicit state based on an output of the recurrent neural network.

11. The apparatus according to claim 10, wherein the recurrent neural network comprises a forward recurrent neural network and a backward recurrent neural network, and
the encoding module being configured to perform encoding processing by sequentially inputting the plurality of sets of coordinate data into the trained recurrent neural network, and generate the encoded implicit state based on the output of the recurrent neural network comprises the encoding module being configured to:
sequentially input the plurality of sets of coordinate data into the forward recurrent neural network in a chronological order, and generate a forward implicit state based on an output of the forward recurrent neural network,
sequentially input the plurality of sets of coordinate data into the backward recurrent neural network in a reverse chronological order, and generate a backward implicit state based on an output of the backward recurrent neural network, and
generate the encoded implicit state by combining the forward implicit state and the backward implicit state.

12. The apparatus according to claim 9, wherein the sampling state module being configured to determine the initial implicit state by sampling based on the implicit state probability distribution comprises the sampling state module being configured to:
perform random sampling based on the implicit state probability distribution, to obtain an implicit random vector z, and map the implicit random vector z into the initial implicit state h₀ for decoding.

13. The apparatus according to claim 12, wherein the decoding sampling module comprises:
a decoding unit configured to perform decoding processing on an (i−1)th implicit state based on the implicit random vector z and (i−1)th new coordinate data to determine an i-th implicit state and an i-th coordinate data probability distribution, wherein the (i−1)th new coordinate data comprises (i−1)th new coordinate data of the target object and (i−1)th new coordinate data of the interactive object, and the i-th coordinate data probability distribution comprises an i-th first coordinate data probability distribution and an i-th second coordinate data probability distribution, an initial value of the (i−1)th new coordinate data comprises preset initial coordinate data of the target object and preset initial coordinate data of the interactive object, and an initial value of the (i−1)th implicit state is the initial implicit state h₀;
a sampling unit configured to determine i-th first new coordinate data of the target object by sampling based on the i-th first coordinate data probability distribution, and determine i-th second new coordinate data of the interactive object by sampling based on the i-th second coordinate data probability distribution;
a sequence generating unit configured to increment i, and repeat processes of determining the first new coordinate data and the second new coordinate data, until decoding ends, generate the new coordinate sequence of the target object based on all of the first new coordinate data, and generate the new coordinate sequence of the interactive object based on all of the second new coordinate data.

14. (canceled)

15. A computer-readable storage medium having stored thereon a computer program, wherein the computer program, when executed by a processor, performs:
obtaining a first basic coordinate sequence of a target object and a second basic coordinate sequence of an interactive object, and performing encoding processing on the first basic coordinate sequence and the second basic coordinate sequence to generate an encoded implicit state;
determining an implicit state probability distribution corresponding to the encoded implicit state based on the encoded implicit state, and determining an initial implicit state by sampling based on the implicit state probability distribution; and
performing decoding processing on the initial implicit state to determine a first coordinate sequence probability distribution of the target object and a second coordinate sequence probability distribution of the interactive object, determining a new coordinate sequence of the target object by sampling based on the first coordinate sequence probability distribution, and determining a new coordinate sequence of the interactive object by sampling based on the second coordinate sequence probability distribution.
